(19) United States
(12) Patent Application Publication
(10) Pub. No.: US 2025/0075761 A1
(43) Pub. Date: Mar. 6, 2025

(54) Cast-Iron Bridge of a Disc Brake

(71) Applicant: KNORR-BREMSE System fuer Nutzfahrzeuge GmbH, Muenchen (DE)

(72) Inventor: Martin HEINDL, Eging am See (DE)

(21) Appl. No.: 18/820,418

(22) Filed: Aug. 30, 2024

(30) Foreign Application Priority Data
Aug. 31, 2023 (DE) 20 2023 104 959.1

(51) Int. Cl. F16D 65/18

(52) U.S. Cl. CPC F16D 65/183; F16D 2200/0013

(57) ABSTRACT

A disc brake component, includes: a cast-iron bridge having two passage openings, which are connected to one another by a bridge body and are each configured to receive an actuating spindle, wherein a mold parting line delimiting a draft angle is formed at a distance from an outer edge of the bridge body for manufacturing purposes, and the mold parting line runs parallel to a profile of the outer edge associated with the mold parting line of the bridge body.

### CROSS REFERENCE TO RELATED APPLICATION

This application claims priority under 35 U.S.C. § 119 from German Patent Application No. 2020 23 104959.1, filed Aug. 31, 2023, the entire disclosure of which is herein expressly incorporated by reference.

### BACKGROUND AND SUMMARY

The invention relates to a cast-iron bridge of a disc brake for a utility vehicle.

Such a bridge is a constituent part of a brake-application device, which is arranged in a brake caliper and also has a pivotable brake lever. During braking, the bridge, and brake plungers mounted therein are moved toward a brake disc. The brake plungers are pushed against a brake pad that is pressed against a brake disc on the vehicle side.

The bridge is manufactured in a casting process, for which a split mold is used, in each case having a bed formed by a mold half.

The straight mold parting profile, which is identifiable by a mold parting line, delimits a technically necessary draft angle, which rises from an outer edge of the bridge, but leads to a significantly thinner wall thickness. This is the region that is subject to the greatest loading when the bridge is in use.

However, the wall thickness cannot be increased to the desired extent required for optimum load-bearing capacity, given the installation space conditions specified by the brake caliper.

This results in the bridge at least having a limited service life and, if necessary, i.e. if the continuous loading in the corresponding region becomes too great, needing to be replaced.

Irrespective of the fact that the wall thickness of the bridge in this region cannot be designed to be arbitrarily thick on account of the space conditions alone, such a design would also entail a significant increase in the weight of the bridge, which would be contrary to the constant demand for a weight reduction of the disc brake as a whole.

Moreover, increasing the wall thickness would lead to an increase in the cost of manufacturing on account of the greater use of material, which would likewise be counterproductive.

The invention is based on the object of further developing a bridge of the generic type such that its load-bearing capacity is increased with low outlay in terms of design and manufacturing.

This object is achieved by way of a bridge having the features of the independent claim(s).

According to the invention, the mold parting line runs parallel to the profile of the associated outer edge of the bridge body, this outer edge extending from one passage opening to the other, said passage openings being arranged parallel to and at a distance from one another and each serving to receive an actuating spindle.

Preferably, the outer edge is significant here, having a cavity of the bridge body for receiving a compression spring, which, when the disc brake is fully formed, is supported on the other side on a closure cover, which is used to close the receiving space of the brake caliper of the disc brake.

The design according to the invention results in the mold parting line being closer to the outer edge of the bridge body than the mold parting line according to the prior art. This results in both a significant reinforcement of the wall in the load-bearing region and a reduction of the wall in the rest of the profile, in relation to the axial extent of the passage openings.

While this region has hitherto been overdimensioned, in particular since the loading on the side of the mold parting line facing away from the outer edge is lower, the wall thickness in this region is now optimized.

This results in a material saving, which leads to both a reduction in the weight of the bridge and a reduction in manufacturing costs.

The mold parting angle, from the mold parting line to the outer edge, required for manufacturing purposes is provided with the taper required for demolding, the length of the mold parting angle, as seen in the cross section of the bridge head, being shorter than that according to the prior art, but, as explained, sufficient for demolding after casting.

As mentioned, the mold parting line is associated with the outer edge of the bridge body, said outer edge delimiting the cavity for the abovementioned compression spring. However, it is also contemplated for the mold parting line and thus the mold parting angle to be provided on the opposite side, i.e. on both wide sides of the bridge body.

The bridge according to the invention corresponds in terms of its essential outer dimensions to a bridge according to the prior art, i.e., the specified installation space dimensions are complied with without restriction. Moreover, the novel bridge can be manufactured at no extra cost compared to a known one and can be used as a replacement part in an existing disc brake if required.

Further advantageous configurations of the invention are characterized in the dependent claims.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a bridge according to the prior art;

FIG. 2 is a bridge according to an embodiment of the invention, likewise illustrated in perspective;

FIG. 3 is a cross section through the bridge according to FIG. 2; and

FIG. 4 is an enlarged detail of the bridge according to FIG. 3, according to the detail designation A in FIG. 3.

### DETAILED DESCRIPTION OF THE DRAWINGS

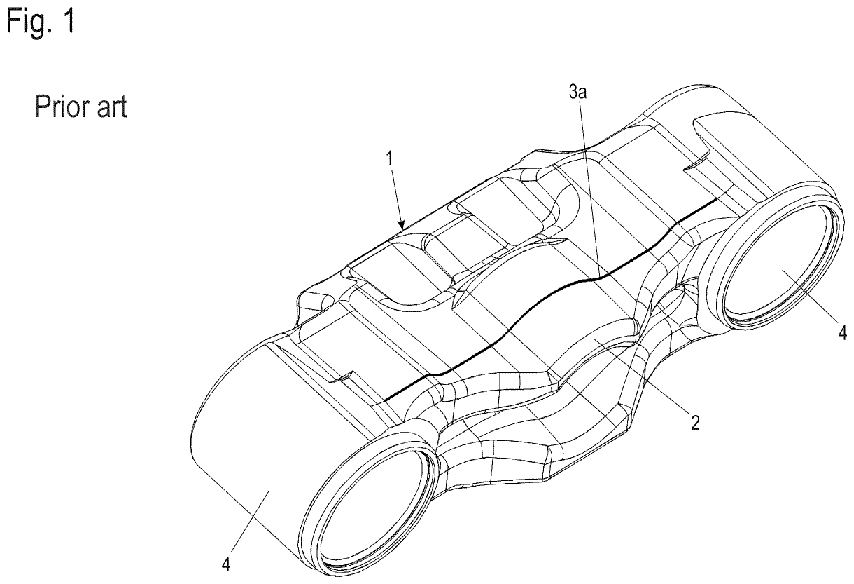

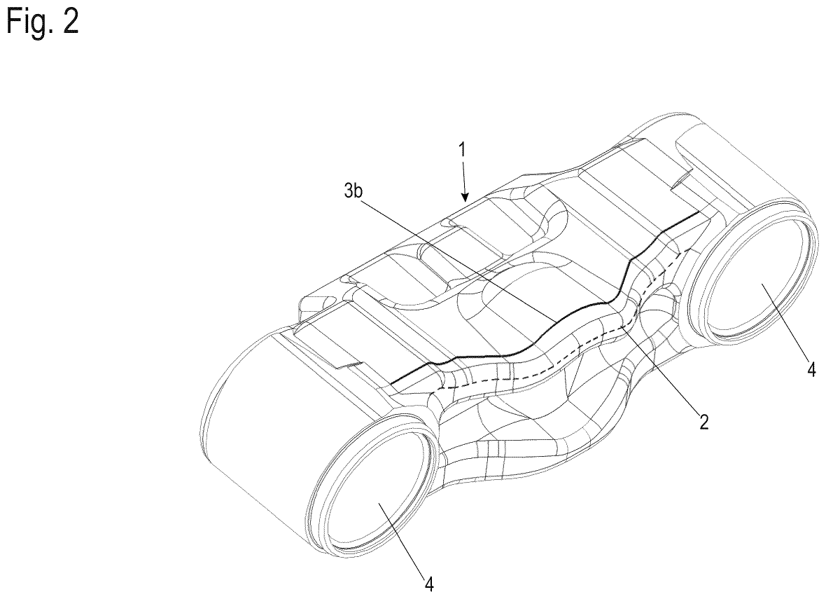

FIGS. 1 and 2 illustrate a cast-iron bridge of a disc brake, having two passage openings 4, which are connected to one another by a bridge body 1, run parallel to and at a distance from one another, and each serve to receive an actuating spindle (not shown).

FIG. 1 depicts the bridge according to the prior art, in the case of which a mold parting line 3a), which delimits a draft angle and extends linearly over the bridge body 1 from one passage opening 4 to the other, is formed at a distance from an outer edge 2 of the bridge body 1 for manufacturing purposes.

FIG. 2 shows a bridge according to an embodiment of the invention, in the case of which the mold parting line 3b runs parallel to the profile of the associated outer edge 2 of the bridge body 1.

It can be seen that the outer edge 2 has a contour that deviates from the linear profile, as does the mold parting line 3b.

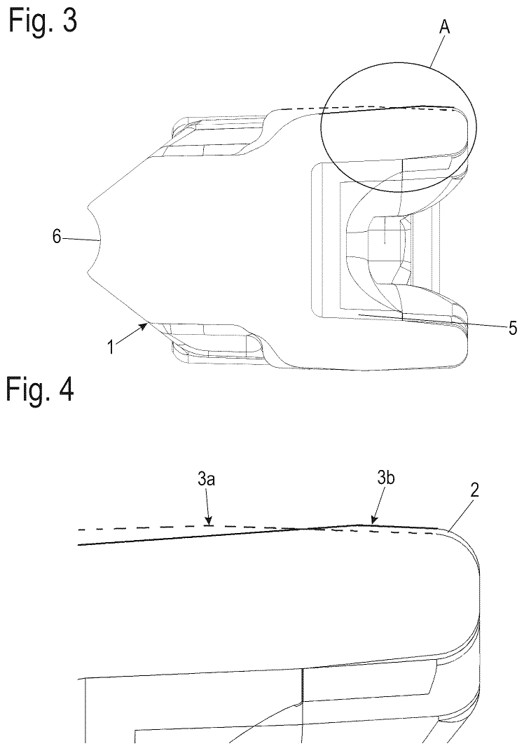

FIG. 3 illustrates a cross section through the bridge body 1, having a recess 6 formed on one side for the abutment of a brake lever (not shown) and an opposite cavity 5 for receiving a compression spring, which compression spring is supported on a closure cover (not shown) of the brake caliper when the bridge is in the mounted position.

The mold parting angle is provided in the top-side wall region of the bridge body 1 delimiting the cavity 5, it being possible for the mold parting angle to be provided on the opposite wall regions.

FIG. 4 shows an enlarged detail according to the label A in FIG. 3, which depicts a part of the wall of the bridge body 1.

For clarification of the invention, the mold parting line 3b can be seen, as can the mold parting line 3a according to the prior art.

Thus, it can be seen that the wall in the region of the mold parting line 3b is thicker than the wall according to the prior art in this region, the mold parting line 3a running significantly further away from the outer edge 2, which is formed by the end side of the wall.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Bridge body
2 Outer edge
3a Mold parting line
3b Mold parting line
4 Passage opening
5 Cavity
6 Recess

What is claimed is:

1. A disc brake component, comprising:
a cast-iron bridge having two passage openings, which are connected to one another by a bridge body and are each configured to receive an actuating spindle, wherein
a mold parting line delimiting a draft angle is formed at a distance from an outer edge of the bridge body for manufacturing purposes, and
the mold parting line runs parallel to a profile of the outer edge associated with the mold parting line of the bridge body.

2. The component according to claim 1, wherein
a draft angle is provided on both wide sides of the bridge body.

3. The component according to claim 1, wherein
the mold parting line is provided adjacent to the outer edge, which outer edge delimits a cavity for a compression spring.

4. The component according to claim 1, wherein
the profile of the outer edge runs in a manner that deviates from a linear alignment.

5. The component according to claim 3, wherein
the outer edge is formed by an end side of a wall delimiting the cavity.
